(19) United States
(12) Patent Application Publication
(10) Pub. No.: US 2009/0232633 A1
(43) Pub. Date: Sep. 17, 2009

(54) CART FOR A TRAILER HITCH

(76) Inventors: Randy Stamps, Bethel, OH (US); Lara Stamps, Bethel, OH (US)

Correspondence Address: WOOD, HERRON & EVANS, LLP, 2700 CAREW TOWER, 441 VINE STREET, CINCINNATI, OH, 45202, US

(21) Appl. No.: 12/129,151

(22) Filed: May 29, 2008

Related U.S. Application Data
(60) Provisional application No. 61/035,407, filed on Mar. 11, 2008.

(51) Int. Cl. B66F 7/06

(52) U.S. Cl. 414/814; 280/423.1

(57) ABSTRACT

A sturdy attractive cart with an upper portion, a lower portion, wheels, and steering suitable for both maneuvering while in a store, and on more rugged terrain. The cart may be carried suspended from a trailer hitch behind a motor vehicle. The cart has a vertical positioner to raise and lower the upper portion and lower portion relative to the other. The cart may be used as an off-road utility trailer, being towed by a vehicle.

### RELATED APPLICATION

Pursuant to 37 C.F.R. § 1.78(a)(4), this application claims the benefit or and priority to prior filed co-pending Provisional Application Ser. No. 60/035,407, filed Mar. 11, 2008, which is expressly incorporated herein by reference.

### FIELD OF THE INVENTION

The present invention generally relates to a goods-carrying cart or utility trailer that can also be carried by a trailer hitch on a motor vehicle.

### BACKGROUND

People often shop for heavy items, for example, building supplies or bags of topsoil. While shopping, the heavy items are lifted into a shopping cart. After checkout, the same items are lifted from the cart into a motor vehicle. Upon arriving home, the items are lifted out of the vehicle, and transported to the specific location where they are needed. A back yard, for example. This lifting and moving may cause fatigue and injury. Similar efforts are required for other activities, such as, for example, vegetable gardening at a food cooperative, and car camping. A solution is needed to minimize the lifting and moving involved.

### SUMMARY OF THE INVENTION

A sturdy, attractive cart with wheels and steering suitable for both maneuvering while in a store, and on more rugged terrain. The cart may be carried on a trailer hitch behind a motor vehicle. The cart has mechanical lift assistance to help the user mount and dismount the cart from the trailer hitch. The cart may also include a pull handle for attachment to a lawn tractor, ATV or other utility vehicle. The mechanical lift assistance, or positioning device, may be provided by a scissor support and hydraulic system.

Moreover, the invention encompasses carts for carrying goods, utility trailers, and transportable, adjustable-height workstations. The features of these types of devices are shown and described in greater detail hereinbelow.

Additional features and advantages of the present invention are described in, and will be apparent from, the detailed description of the presently preferred embodiments and from the drawings.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention.

FIGS. 1-2 are perspective schematic views illustrating a first embodiment of the invention having a scissors-raising design.

FIG. 3 is a partially exploded perspective schematic view illustrating the embodiment of FIG. 1-2.

FIGS. 4-6 are perspective schematic views illustrating a method of use for the embodiments of the current invention.

FIG. 7 is a partially exploded perspective schematic view illustrating a second embodiment of the current invention.

FIG. 8 is a perspective schematic view illustrating a cargo net or any similar system used to hold the cargo in place.

FIGS. 9-10 are perspective schematic views illustrating a third embodiment of the current invention.

FIG. 11 is a partially exploded perspective schematic view illustrating the embodiment of FIG. 9-10.

FIG. 12 is a perspective schematic view illustrating additional aspects of the method of use of the embodiment of FIGS. 9-10.

FIGS. 13-14 are perspective schematic views illustrating additional features for use in carrying cargo in the embodiments of the current invention.

FIG. 15 is a partial schematic perspective view illustrating a fourth embodiment of the current invention.

FIG. 16 is a schematic perspective view of a fifth embodiment of the current invention.

### DETAILED DESCRIPTION

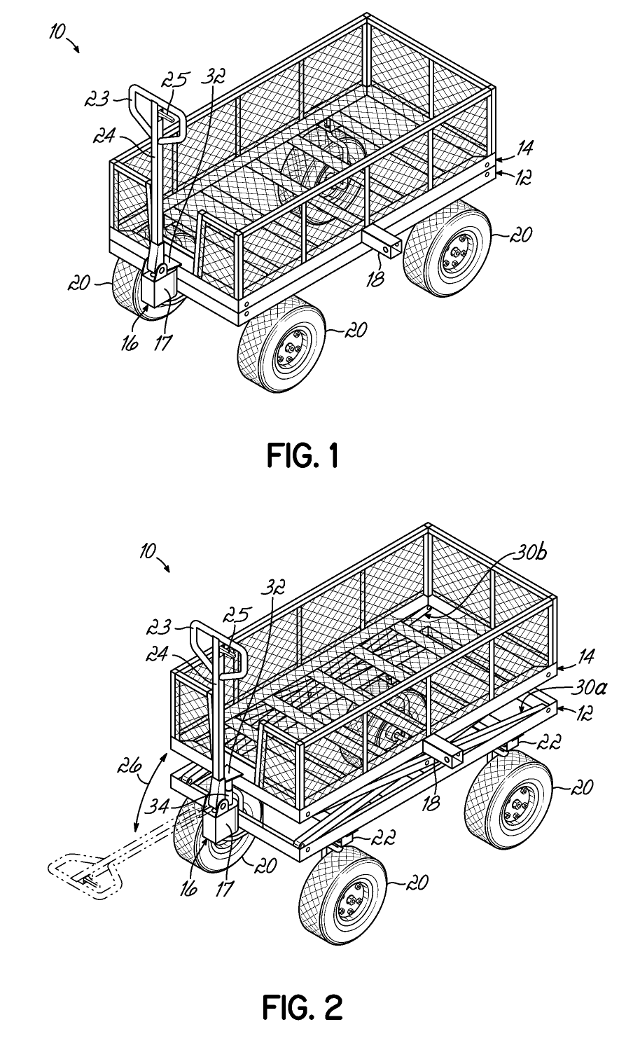

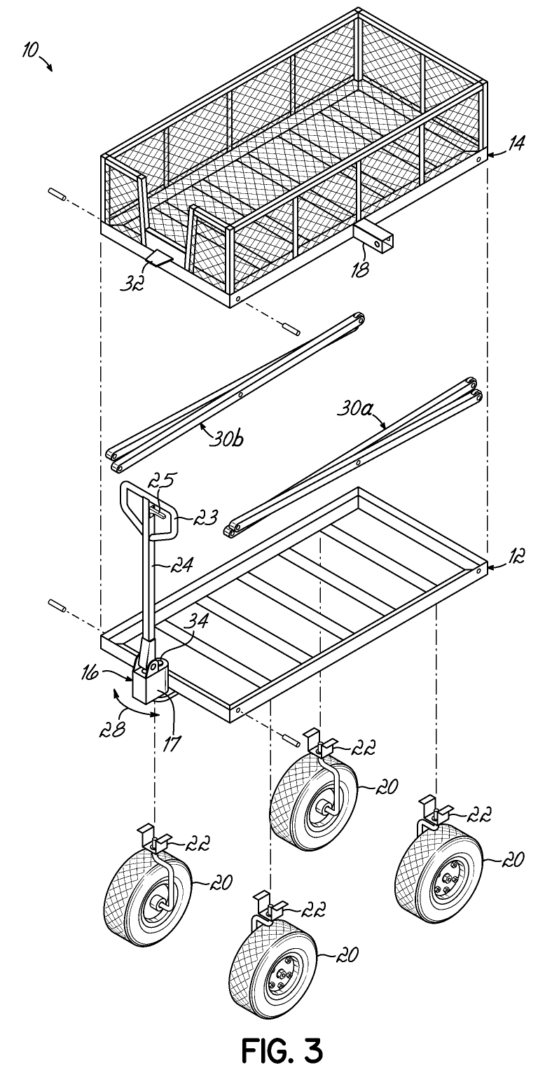

FIGS. 1-3 illustrate a wheeled cart 10 having a lower portion 12, an upper portion 14, a mechanical lifter 16, a hitch 18, and four tires 20 each on a wheel caster 22 that rotates 360°. Preferably the tires 20 are pneumatic and of appropriate diameter and width to ease transportation over soft and irregular ground. The mechanical lifter 16 comprises a hydraulic pump 17 having a handle 23, an arm 24 and an activation lever 25. The handle 23, arm 24, and activation lever 25 are like those commonly used on pallet jacks. The arm 24 can rotate relative to the lower portion 12 as indicated by the arrows 26, 28 in FIGS. 2, 3 and 5. Each of a pair of scissoring supports 30a, 30b is pivotally connected to the lower portion 12 and the upper portion 14. A load tongue 32 is pushed up and pulled down by a hydraulic cylinder 34 that is driven by the hydraulic pump 17. In one embodiment, the hydraulic cylinder 34 is a dual action cylinder with valving to hydraulically move it in both directions.

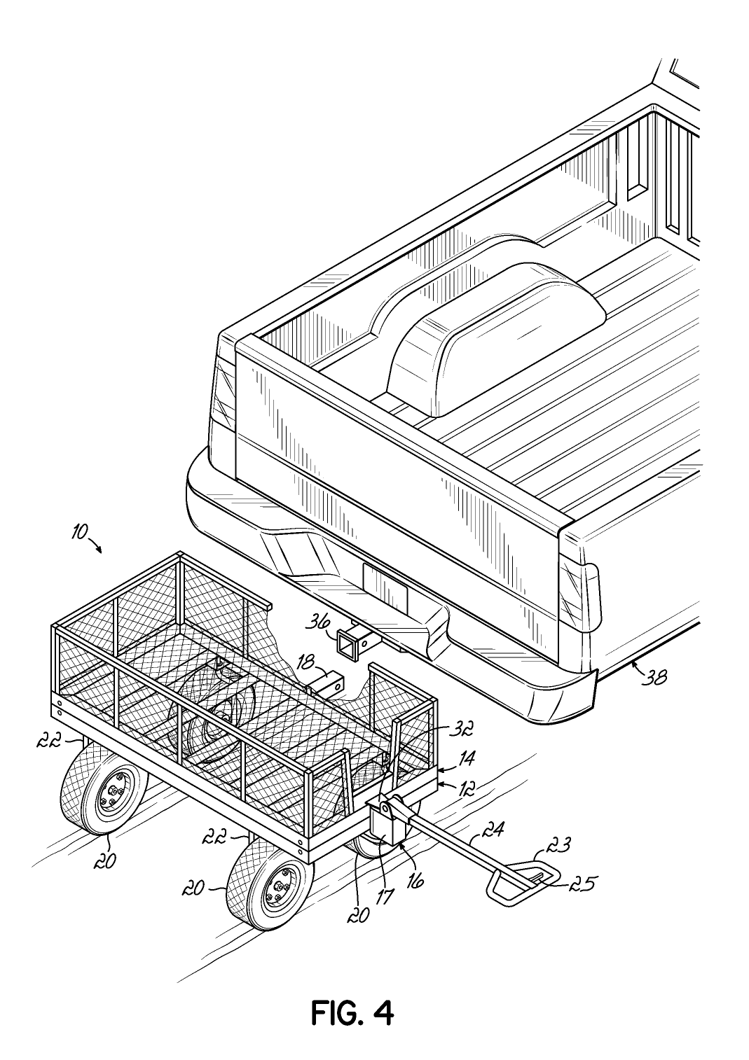

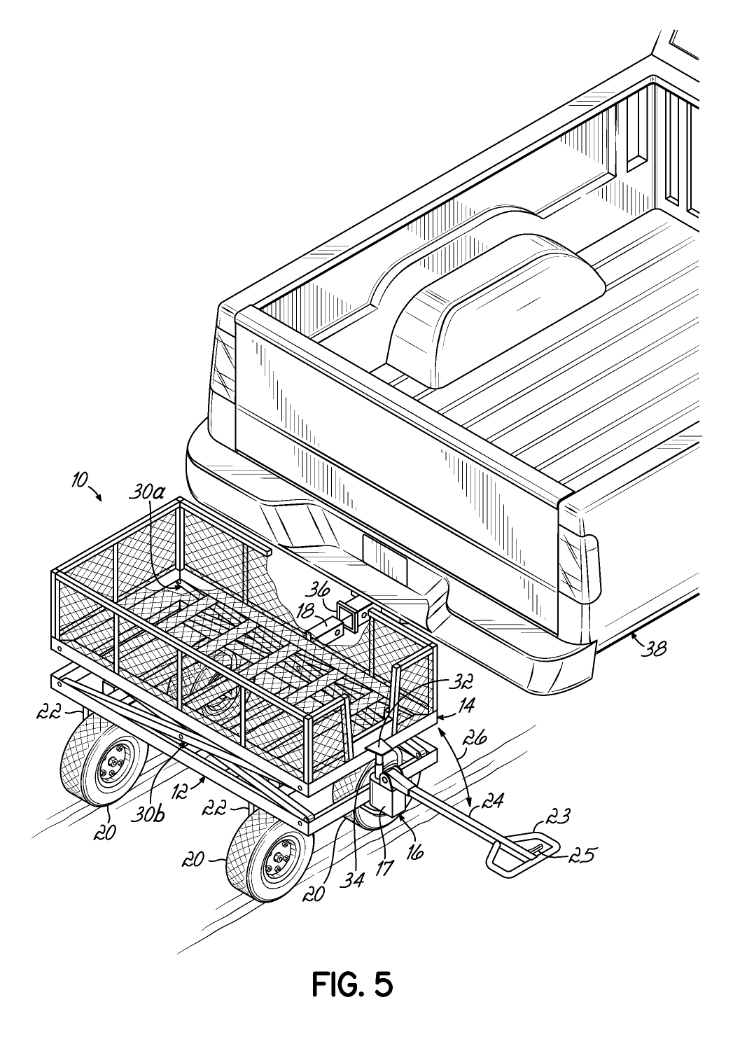

Operation of the cart is illustrated in FIGS. 4, 5 and 6. The cart is shown without a load for purposes of clarity. In FIG. 4, a user (not shown) positions the hitch 18 in approximate alignment behind and below a complementary trailer hitch 36 on a motor vehicle 38. The 360° rotatable wheel casters 22 make this an easy task. In FIG. 5, the arm 24 is pumped raising the hydraulic cylinder 34 against the load tongue 32 and lifting the upper portion 14 to a level in alignment with the trailer hitch 36. The cart 10 is pushed until the trailer hitch 36 and the hitch 18 engage. The cart 10 is then locked to the motor vehicle 38 by conventional means.

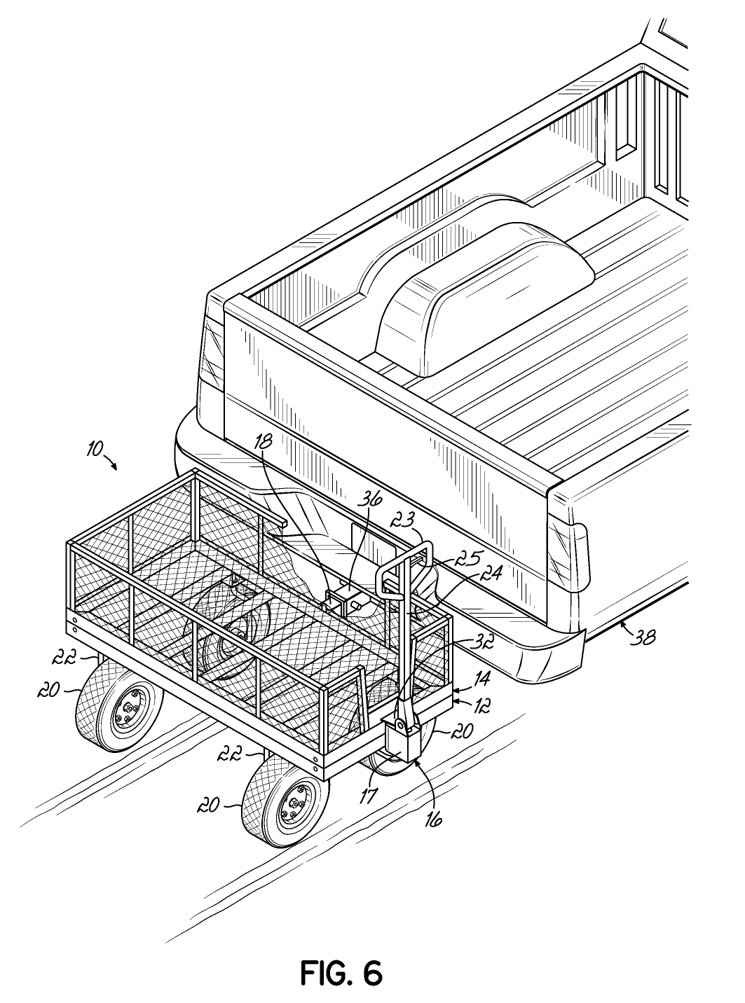

From FIG. 5 to FIG. 6, the lower portion 12 and the tires 20 are lifted above the ground. The lifting may be done in a variety of ways, depending upon the actual configuration of the mechanical lifter 16. If the mechanical lifter is all hydraulic based, then the hydraulic cylinder 34 may be a dual action cylinder that can both push the load tongue 32 upwards, and pull the load tongue 32 downwards. Such a cylinder may be controlled by a valve (not shown) that is activated by the activation lever 25, or a selector (not shown) may be directly on the valve. Since the lower portion 12 weighs less than the motor vehicle 38, the tires 20 will be lifted off the ground. Other mechanical lifters 16 may be used, for example, springs, cranks, screws, or pulleys. Finally, the arm 24 is secured in its upright position, so it will not interfere with movement of the motor vehicle 38.

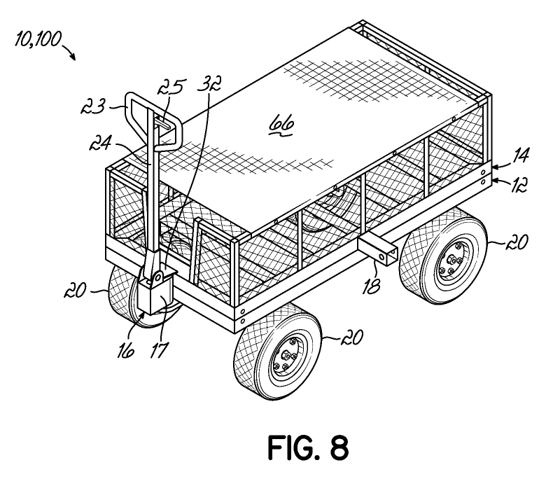

In FIG. 6, the vehicle and cart are ready to be driven to their destination. Optionally, a cargo securing cover 66 (FIG. 8) or straps (not shown) may be used to retain the load. At a destination, the tires 20 are lowered and the cart 10 removed in the reverse order described for loading the cart onto the vehicle.

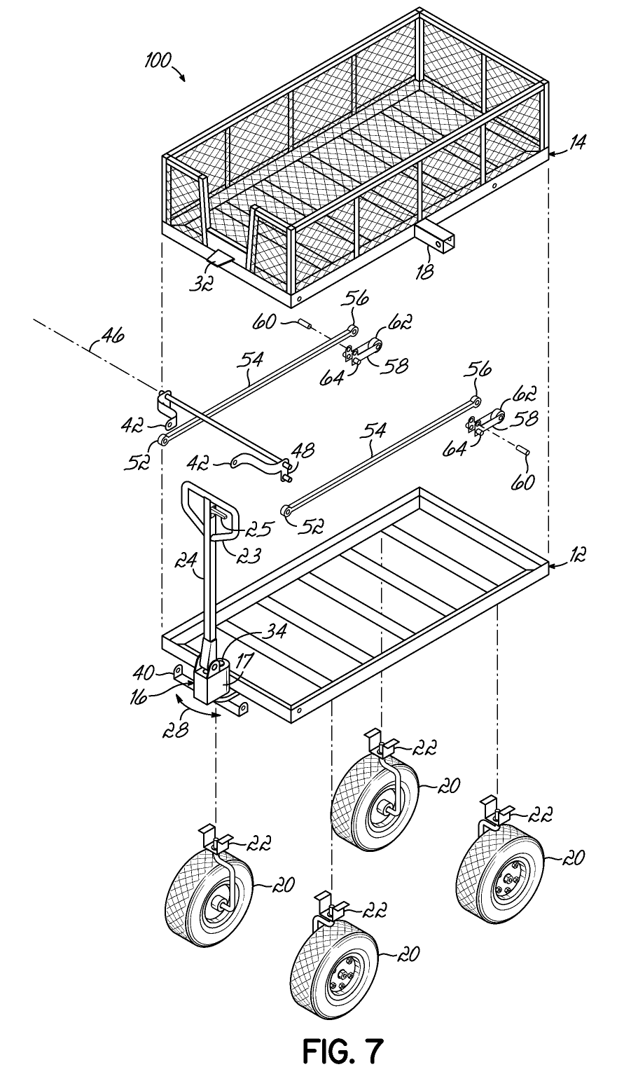

FIG. 7 illustrates a second embodiment of the current invention, a cart 100. Arm 24 of mechanical lifter 16 is coupled to a lower link 40. Lower link 40 is coupled to a front portion 42 of a lifting link 44. Lifting link 44 has an axis 46 and an aft portion 48. Aft portion 48 is pivotally coupled to first ends 52 of a pair of pushrods 54. Second ends 56 of the pushrods 54 are pivotally coupled to rocker arms 58 by fasteners 60. Rocker arms 58 have load wheels 62 and base pins 64 that pivotally couple the rocker arms 58 to the lower portion 12.

In operation, when the arm 24 is pumped and lower link 40 is moved vertically, lifting link 44 is pivoted about axis 46 so that the pushrods 54 pivot the rocker arms 58 around the base pins 64. The rocker arms 58 move the load wheels 62 vertically, lifting the upper portion 14 of the cart 100 into a higher position. As in previous figures, the hitch 18 of the upper portion 14 of the cart 100 may then be mated to the trailer hitch 36 on a motor vehicle 38. The lower portion 12 is raised to lift the tires 20 from the ground by the methods described with regards to embodiment 10.

FIG. 8 Illustrates a cargo securing cover 66 that may be used on either of the previous embodiments 10, 100. A cargo securing cover 66 is just one example of many alternative forms for securing the cargo in the cart 10, 100.

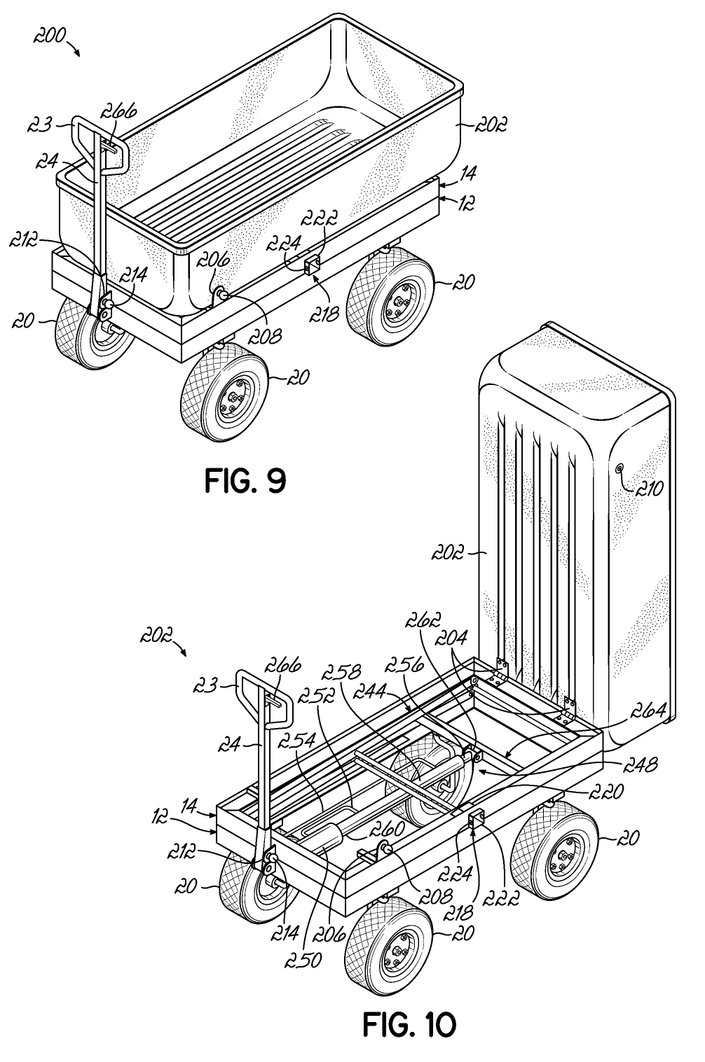

FIGS. 9-12 illustrate a third embodiment 200 of the current invention. This embodiment has some mechanical components that are different than those used in the previous embodiments. These mechanical components offer increased ground clearance with the road when the cart is suspended from a motor vehicle 38. Aspects unique to this embodiment will be described in detail, while previously described features will not be further described.

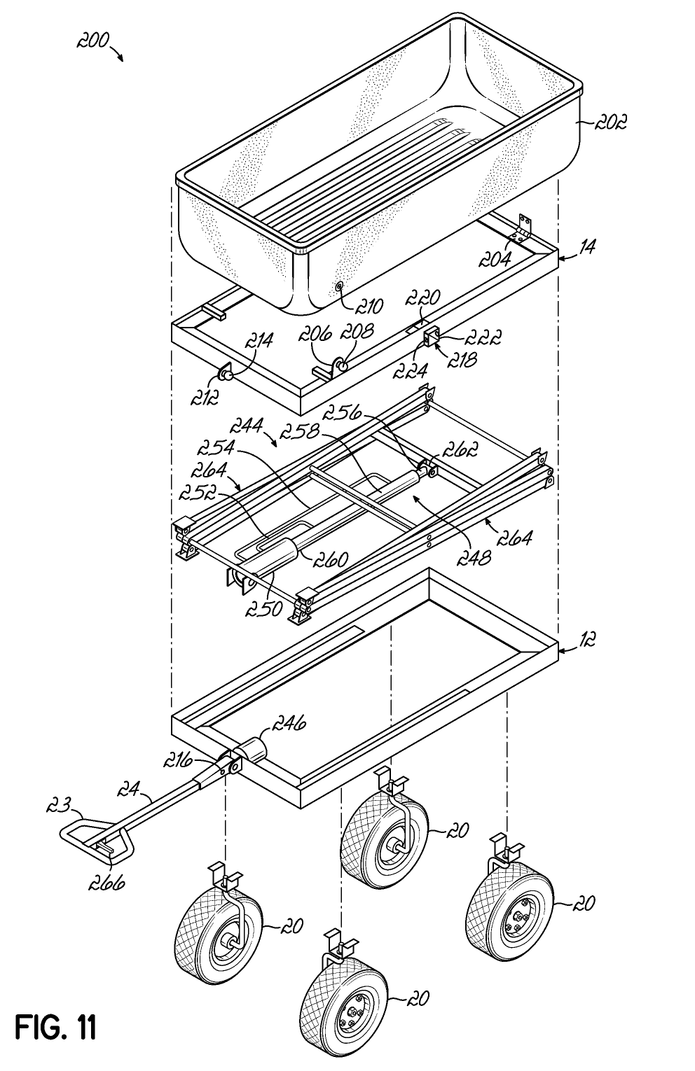

A cart 200 has a lower portion 12 and an upper portion 14 that holds a tub 202 pivotally coupled to the upper portion 14 by hinges 204 that allow cargo to be dumped when desired. A locking mechanism 206, comprising a retained pin 208 and a matching cavity 210, prevents the tub 202 from pivoting unintentionally, such as when the motor vehicle 38 turns a corner. A similar locking mechanism 212 to keep the arm 24 upright comprises a retained pin 214 and a hole 216 (FIG. 11) in the arm 24. Locking the handle upright not only is necessary when transporting the cart on the back of the vehicle 38, but it can also make it easier for the user to push the cart 200 when rounding tight corners, such as when purchasing materials in a home improvement center. The tub 202 in this illustration is closed-sided, and suitable for carrying bulk materials as well as larger items. Tub 202 is preferably plastic to minimize weight, but may be made of any suitable material and be of any design. It may also be a flatbed, having no sides.

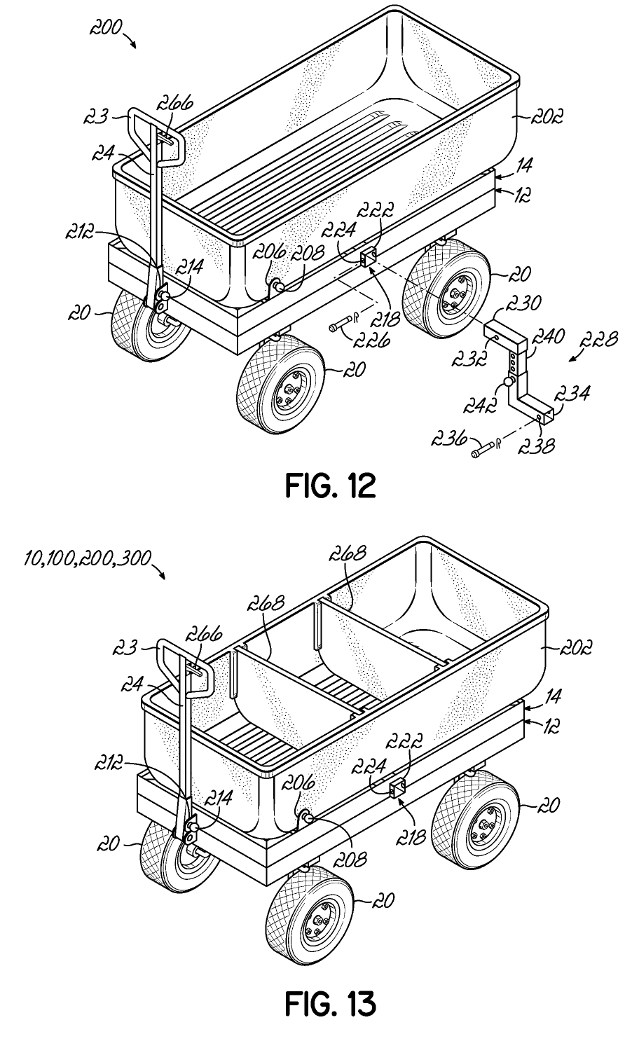

A hitch 218 has a large portion 220 that is interior to the upper portion 14, and a small portion 222, extending exteriorly so that a hole 224 is accessible to receive a locking pin 226 (FIG. 12). A height extender 228 has an upper end 230 sized to enter the hitch 218 and a hole 232 to be locked by the locking pin 226. A lower end 234 is sized to enter the complementary trailer hitch 36 and be locked in by a fastener 236 through a hole 238. Between the two ends 230, 234 is a vertical portion 240 that is of adjustable length. A fastener 242 maintains a chosen length. Vertical portion 240 need not be adjustable for the practicing of this invention, however and adjustable version is shown. Height extender 228 will also work if it is of single piece construction, without adjustment. The combination of the vertical portion 240 and the two ends 230, 234 enable the cart 200 to be suspended higher off the road by a motor vehicle 38 than a comparable cart 10. An additional advantage provided by height extender 228 is that since it is removable, the effective width of the cart 200 is smaller than a comparable cart 10. In other words, hitch 218 protrudes less than hitch 18. A narrower cart may be more easily pulled through narrow aisles and other tight spaces.

Cart 200 has a vertical positioner 244 comprising a hydraulic pump 246 having arm 24 that is manually moved to provide hydraulic pressure. The hydraulic pump 246 is coupled to a hydraulic cylinder 248 through a valve 250 and hydraulic lines 252, 254. The hydraulic cylinder 248 has an inner portion 256 that extends or retracts into an outer portion 258 to lengthen or shorten the overall length of the hydraulic cylinder 248. A stationary end 260 and a moving end 262 of the hydraulic cylinder 248 are arranged with a scissor support 264 in a way that is not new in the art, and is used in a variety of lifting devices such as on platforms used by construction workers to reach tall ceilings. A user selects the output from the valve 250 consistent with the lengthening or shortening of the hydraulic cylinder 248. As the hydraulic cylinder 248 lengthens the scissor support 264 extends bringing the upper portion 14 further from the lower portion 12. Conversely as the hydraulic cylinder 248 contracts, the scissor support 264 retracts bringing the upper portion 14 closer to the lower portion 12. As the hydraulic cylinder 248, and in this case the valve 250 that is mounted in-line changes length, it also changes angle since it is attached to a rising portion of the scissor support 264. Conveniently, a valve selector switch 266 is positioned on the handle 23 to allow the user to select which output valve 250 provides.

In use, the cart 200 is used the same as the cart 10 described with reference to FIGS. 4-6. Changes that are easily understood by one skilled in the art include placing the height extender 228 in the hitch 218 so that upon the first pumping of the arm 24, the upper portion 14 is brought to a height well above the trailer hitch 36 when the lower end 234 is level with trailer hitch 36. Then, after securing the lower end 234 into the trailer hitch 36, the position of valve 250 is changed by valve selector switch 266. The second pumping of the arm 24 raises the lower portion 12 and the tires 20 well above the road.

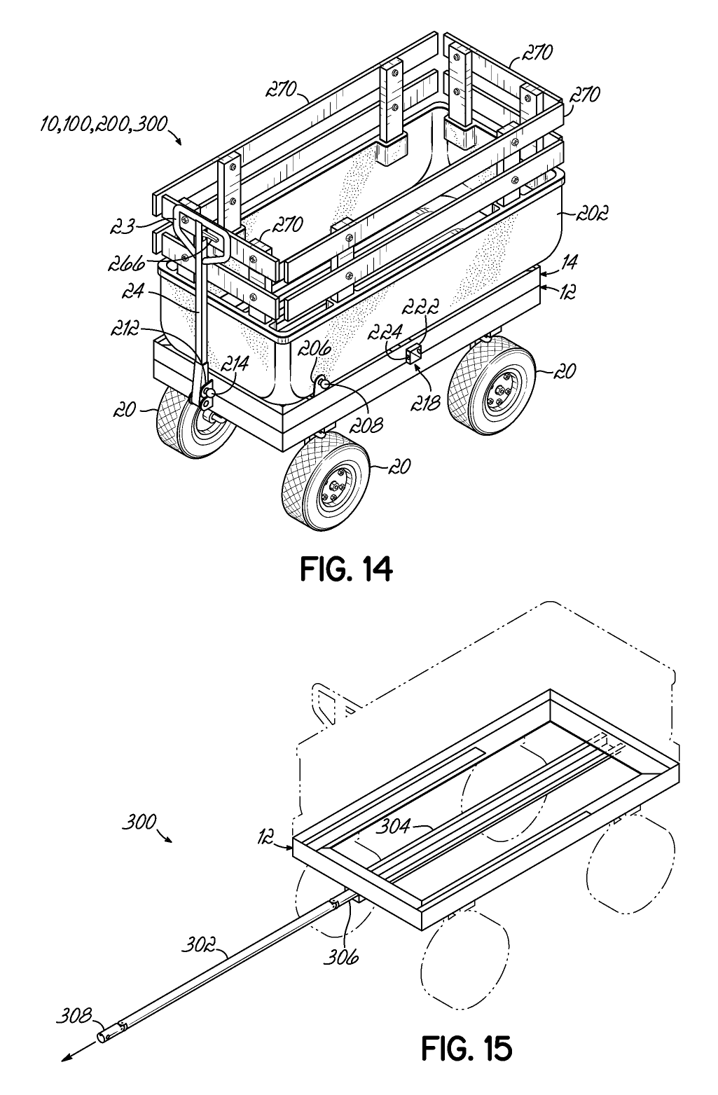

FIGS. 13-14 show additional features adaptable to any of the previous embodiments, such as cargo dividers 268 and cargo rails 270.

In FIG. 15, a fourth embodiment in the form of a utility trailer 300 is illustrated. Other aspects of the cart are the same as shown in previous figures, and have been omitted for clarity. Heretofore, the embodiments 10, 100, 200, have had two forms of transport. The first involved transporting along a public road without coming in contact with the surface of the road. The second involved transporting over other terrain, but only to the extent that power available from a human grasping and pulling the handle 23 made it possible. Utility trailer 300, on the other hand, includes a tow bar 302 extending from the lower portion 12. Tow bar 302 may be stored in a tow bar channel 304 under the lower portion 12. A first end 306 of the tow bar is fastened to the lower portion 12 and a second end 308 is adapted to be hitched to any vehicle, for example, an ATV (all terrain vehicle), a golf cart, or a lawn tractor so that the utility trailer 300 may be easily moved while it is not attached to motor vehicle 38. Pivoting of the tow bar 302 to accommodate uneven terrain may be provided by a variety of mechanical systems for attachment, well known in the art. For example, the pivoting may be supplied in the form of a hole or ring that has a loose fit over a pin, thus allowing multiple directions of pivot.

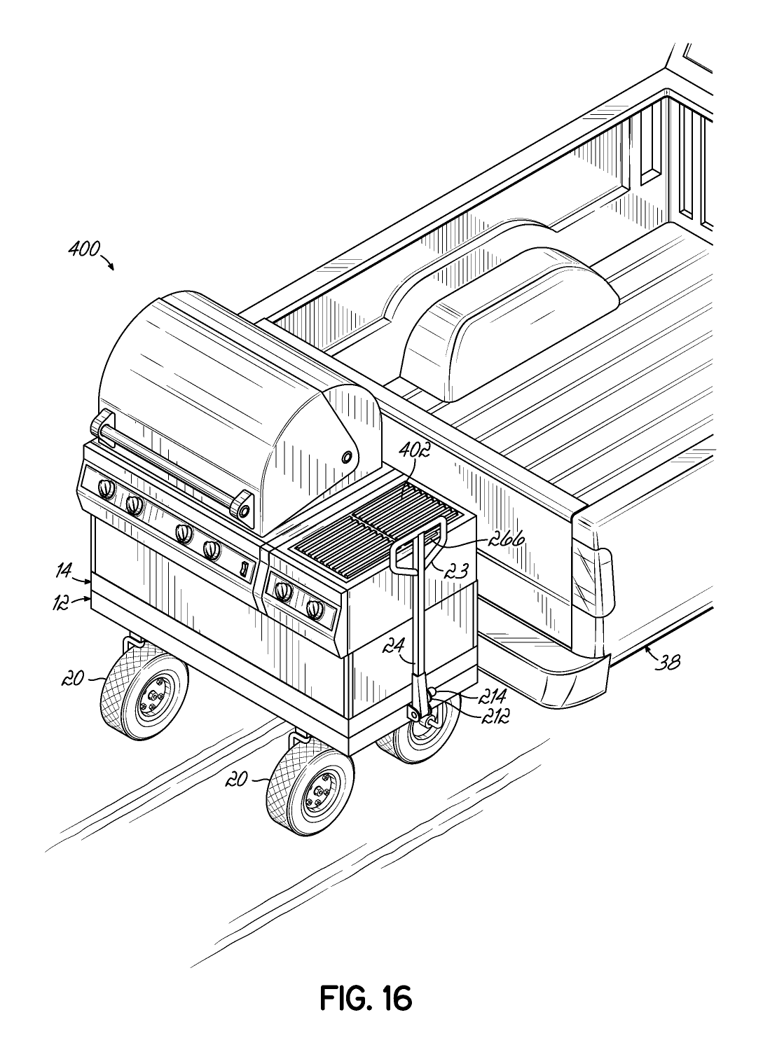

A fifth embodiment 400 of the current invention is a workstation 400 adjustable to various working heights. Workstation 400 is transportable on the back of a motor vehicle 38 to a location at which it can be used. Unlike existing trailer designs, transportation is accomplished without the need for a roadworthy suspension, tires, or licensing since the workstation 400 is not actually in contact with the road. Thus, the current invention also comprises a transportable portable workstation 400 selectively positionable to various heights. Further, the workstation 400 may be in the form of an appliance top such as a grill cooking surface 402 shown in FIG. 16. In this example the grill may be transported in a short configuration, and then, by pumping arm 24, it may be raised to a desired working height once removed from the motor vehicle 38.

Although embodiment 400 was with a single item, a grill, it is contemplated that this invention may also be practiced with multiple items that are swapped out as needed by having fasteners or a similar system to mount an item to upper portion 14. For example, a grill may be used one time, and a baseball team's equipment box the next time. The tub 202 may also be removable. Not all items need be a workstation that can benefit by a change in height. They may in fact be a specialized carrying container or any other item that needs the flexible transportation that this invention can provide.

While the foregoing description has set forth preferred embodiments of the present invention in particular detail, it must be understood that numerous modifications, substitutions and changes can be undertaken without departing from the true spirit and scope of the present invention as defined by the ensuing claims. For example, but not by way of limitation, many of the features shown with one embodiment may be used with other embodiments. The invention is therefore not limited to specific embodiments as described but is only limited as defined by the following claims.

What is claimed is:

1. A cart for carrying goods comprising:
a lower portion having a pull-handle and at least three wheels;
an upper portion having a carrying portion and a hitch, said upper portion coupled above the lower portion;
a positioning device adapted to vertically position the upper portion at a plurality of heights above the lower portion, and to raise the at least three wheels off the ground when the cart is secured to a motor vehicle by the hitch.

2. A cart as in claim 1 wherein the positioning device comprises a scissor support and a hydraulic system to expand and retract the scissor support.

3. A cart as in claim 2 wherein the hydraulic system is pressurized by pumping the pull-handle.

4. A cart as in claim 3 wherein the hydraulic system has at least one cylinder expanding the scissor support when a valve is in a first position, and retracting the scissor support when the valve is in a second position.

5. The cart of claim 1 wherein the at least three wheels have pneumatic tires, and are on casters that rotate 360 degrees.

6. A utility trailer comprising:
a lower portion having a pull-handle for a human hand, a pull-bar for attaching to a utility vehicle, and at least three wheels;
an upper portion having a carrying portion and a hitch, said upper portion coupled above the lower portion;
a positioning device adapted to vertically position the upper portion at a plurality of heights above the lower portion, and to raise the at least three wheels off the ground when the utility trailer is secured to a motor vehicle by the hitch.

7. A utility trailer as in claim 6 wherein the positioning device comprises a scissor support and a hydraulic system to expand and retract the scissor support.

8. A utility trailer as in claim 7 wherein the hydraulic system is pressurized by pumping the pull-handle.

9. A utility trailer as in claim 8 wherein the hydraulic system has at least one cylinder expanding the scissor support when a valve is in a first position, and retracting the scissor support when the valve is in a second position.

10. The utility trailer of claim 6 wherein the at least three wheels have pneumatic tires, and are on casters that rotate 360 degrees.

11. A transportable adjustable-height workstation comprising:
a lower portion having a pull-handle and at least three wheels;
an upper portion having a work surface and a hitch extending parallel to the bottom of the at least three wheels, said upper portion coupled above the lower portion;
a positioning device adapted to vertically position the upper portion at a plurality of heights above the lower portion, and to raise the at least three wheels off the ground when the transportable adjustable-height workstation is secured to a motor vehicle by the hitch.

12. A transportable adjustable-height workstation as in claim 11 wherein the positioning device comprises a scissor support and a hydraulic system to expand and retract the scissor support.

13. A transportable adjustable-height workstation as in claim 12 wherein the hydraulic system is pressurized by pumping the pull-handle.

14. A transportable adjustable-height workstation as in claim 13 wherein the hydraulic system has at least one cylinder expanding the scissor support when a valve is in a first position, and retracting the scissor support when the valve is in a second position.

15. The transportable adjustable-height workstation of claim 11 wherein the at least three wheels have pneumatic tires, and are on casters that rotate 360 degrees.

16. A method for placing cargo in a position for transport by a motor vehicle comprising;
loading the cargo in a cart that has an upper portion with a hitch, a lower portion with at least three wheels, and a vertical positioning system connecting the upper portion and the lower portion while the upper portion is in a first vertical position;
rolling the cart a first time so that the hitch is in proximity to a mating hitch on the motor vehicle;
actuating the vertical positioning system a first time to move the upper portion to a second vertical position at which the hitch is in alignment with the mating hitch;
rolling the cart a second time to interlock the hitch with the mating hitch; and
actuating the vertical positioning system a second time to bring the lower portion upwards to lift the at least three wheels above the ground so that the cart is suspended from the motor vehicle.
